(19) United States
(12) Patent Application Publication
(10) Pub. No.: US 2026/0261328 A1
(43) Pub. Date: Sep. 3, 2026

(54) ENHANCED COMMUNICATION WITH TERRESTRIAL NETWORKS FOR AERIAL VEHICLES

(71) Applicant: Telefonaktiebolaget LM Ericsson (publ), Stockholm (SE)

(72) Inventor: Ola MELANDER, Würselen (DE)

(73) Assignee: Telefonaktiebolaget LM Ericsson (publ), Stockholm (SE)

(21) Appl. No.: 19/158,037

(22) PCT Filed: Feb. 23, 2023
(86) PCT No.: PCT/EP2023/054630

§ 371 Date: Aug. 19, 2025

(51) Int. Cl. H04B 7/185; H04B 1/40

(52) U.S. Cl. CPC H04B 7/18506; H04B 1/40

(57) ABSTRACT

The invention relates to a transceiver system (100) for an aerial vehicle (300) comprising:
a control entity (150) connected to at least one user equipment and configured to determine flight path data including information about a flight path of the aerial vehicle,
at least 2 antenna entities (1620, 1630) fixedly connected to the aerial vehicle, wherein each antenna entity is connected to a different radio access node of a terrestrial cellular network, wherein the control entity is configured to connect the at least one user equipment to one of the at least 2 antenna entities for a connection to the terrestrial cellular network in dependence of the flight path data.

### TECHNICAL FIELD

The present application relates to a transceiver system for an aerial vehicle and to a method for operating the transceiver system. Furthermore a flight path coordination entity is provided and a method for operating the flight path coordination entity. In addition the aerial vehicle comprising the transceiver system, a system comprising the transceiver system and the flight path coordination entity, a computer program comprising program code and a carrier is provided.

### BACKGROUND

Regulators, governmental functions, enterprises, and private persons put hope that aircrafts, drones, helicopters, and air taxis can use mobile broadband type communication links to Terrestrial cellular networks such as LTE and NR networks. Targeted heights are from the ground level up to ca 12.000 meters height, and at speeds up to ca 1200 km/h.

Mobile network operators and vendors receive requests to provide mobile broadband communication to above and hesitate to respond as the combination of positive business case, Terrestrial network stability and regulatory compliance is not understood.

Air-to-ground LTE networks have been designed and built for example by Deutsche Telekom, Immarsat and Nokia/Skyfive known under the name of European Aviation Network.

3GPP has in Release 15 (Version 15.0.0) studied providing 3-dimensional LTE air coverage and listed conclusions in TR 36.777. Corresponding NR studies are part of the ongoing 3GPP Release 18. ETSI TS 123 501 (Version 17.5.0) Annex F describes the usage of multiple UEs within the same device to achieve user plane redundancy.

Providing 3-dimensional coverage from a Terrestrial LTE/NR network ground up to ca 12.000 meter and at speeds relative to ground up to ca 1200 km/h introduces the following problem domains:
The speed may introduce Doppler effects outside 3GPP specification. When outside the specification, the Doppler effect causes a UE (User Equipment) and base station to use slightly different frequencies for the communication, and this causes the UE and radio base to be unable to communicate. The amount of Doppler effect depends on the UE speed and movement angle to/from the radio base station as well as the communication frequency used. Low band frequencies, like below 1 GHz, are more robust than for example mid-band 3.5 GHz frequencies.
Excessive radio channel interference due to that an airborne UE has line of sight to a much larger amount of radio base stations than a Terrestrial UE. As the spectrum is reused between radio base stations, the UE's transmission intended for one radio base station will inject noise into all other radio base stations within line of sight, and radio base stations transmitting to other UEs at the same time/frequency domain generate noise towards the airborne UE. 3GPP investigations show that a low number of airborne UEs will be enough to disturb both each other's communication, and the communication for Terrestrial UEs.
Mobility procedures, like handover and traffic management logic, become unreliable when an airborne UE has line of sight to a large amount of radio base stations. The 3GPP specifications require the UE to report nearby radio base stations to the network, and based on this reporting, the network instructs the UE what frequencies and radio base stations to use, including when to handover to another frequency/radio base station. This logic as specified by 3GPP does not foresee that a UE can observe a large amount of radio base stations with high signal strength due to line-of-sight conditions, leading to that a UE is directed towards radio base stations that are not able to handle the communication link.
Regulators have specified that the spectrum used for Terrestrial networks shall not be directed into the air due to incumbent spectrum users, like satellite links. Network operators implement this specification by tilting antennas a few degrees towards the ground. Tilting towards the ground is also beneficial to reduce interference between radio base stations. Some energy is however still directed upwards from radio base station antennas due to side and grating lobes. When an airborne UE experiences line-of-sight conditions, the side and grating lobe transmissions/reception are sufficient to create some coverage for airborne UEs. It is however hard or impossible for a network operator to actively manage the side and grating lobe provided coverage.
Mobility procedures, like handover and traffic management logic, also become unreliable when an airborne UE utilizes side and grating lobes. The shape of the side and grating lobes is different (smaller) than the antenna main lobe. This leads to rapid fading and a break down communication when an airborne UE suddenly moves from having good radio conditions through a line-of-sight to a side or grating lobe, to no longer seeing the lobe and losing the radio connection.

Accordingly a need exists to overcome at least some of the problems mentioned above to provide an improved communication between an aerial vehicle and a terrestrial cellular network.

### SUMMARY

According to a first aspect a transceiver system is provided for an aerial vehicle, the transceiver system comprising a control entity connected to at least one user equipment, UE, and configured to determine flight path data including information about a flight path of the aerial vehicle. The transceiver system furthermore comprises at least two antenna entities fixedly connected to the aerial vehicle, wherein each antenna entity is connected to a different radio access node of a terrestrial cellular network. The antenna entity is configured to connect the at least one UE to one of the at least two antenna entities for a connection to the terrestrial cellular network in dependence of the flight path data. Furthermore, the corresponding method for operating the transceiver system is provided which determines the flight path data and connects the at least one UE to one of the at least two antenna entities in dependence on the flight path data. As the transceiver system takes into account the flight path data and selects one of the antenna entities accordingly, an improved connection between the terrestrial cellular network and the aerial vehicle can be obtained.

Furthermore a flight path coordination entity is provided which is located in a terrestrial cellular network wherein the flight path coordination entity is configured to receive flight path data of an aerial vehicle originating from an aerial vehicle connected to the cellular network which indicates a flight path of the aerial vehicle. The flight path coordination entity determines radio network configuration data including locations of radio access nodes used in a radio access network of the terrestrial cellular network. Furthermore, connection data are determined based on the flight path data and the network configuration data which indicate in which direction antenna entities connected to the aerial vehicle should emit signals relative to the flight path and the flight path coordination entity transmits the connection data in direction of the aerial vehicle.

The flight path coordination entity can help to obtain a reliable connection to the terrestrial radio network as it provides information to the aerial vehicle how to direct the antennas during the flight so that the most appropriate radio access node can be selected by the transceiver system in the aerial vehicle.

In addition, a system is provided comprising the transceiver system as discussed above or as disclosed in further detail below and a flight path coordination entity as discussed above or as explained in further detail below. The system may furthermore comprise the aerial vehicle.

Furthermore an aerial vehicle is provided comprising a transceiver system and at least one user equipment which is fixedly connected to the aerial vehicle.

In addition a computer program comprising program code is provided to be executed by at least one processing unit of the transceiver system wherein execution of the program code causes the at least one processing unit to carry out a method as mentioned above or as discussed in further detail below.

In addition the computer program comprising program code is provided to be executed by at least one processing unit of the flight path coordination entity, and the execution of the program code causes the at least one processing unit to carry out a method as mentioned above or as discussed in detail below.

Last but not least a carrier is provided comprising the computer program.

It is to be understood that the features mentioned above and features yet to be explained below can be used not only in the respective combinations indicated, but also in other combinations or in isolation without departing from the scope of the present application. Features of the above-mentioned aspects and embodiments described below may be combined with each other in other embodiments unless explicitly mentioned otherwise.

### BRIEF DESCRIPTION OF THE DRAWINGS

The foregoing and additional features and effects of the application will become apparent from the following detailed description when read in conjunction with the accompanying drawings in which like reference numerals refer to like elements.

FIG. 1 shows a schematic architectural overview of a system in which an aerial vehicle connects to a terrestrial cellular network taking into account flight path data.

FIG. 2 shows a schematic view of a consolidated block diagram and interfaces of the entities involved in a system shown in FIG. 1.

FIG. 3 shows a schematic view of a protocol stack used in a connection between an application running in the aerial vehicle and a network application accessible through the terrestrial cellular network.

FIG. 4 shows a schematic architectural view indicating how a UE operates in measurement procedures for a mobility management.

FIG. 5 shows a schematic view of how an aerial vehicle and which movements of the vehicle are possible in space.

FIG. 6 shows a schematic view how a connection of the aerial vehicle to the radio access network may change in dependence on an orientation and movement of the aerial vehicle.

FIG. 7 shows a schematic view of a placement of antenna entities in the aerial vehicle.

FIG. 8 shows a further schematic view a placement of antenna entities in the aerial vehicle.

FIG. 9 shows a schematic view of how only some of the antennas connected to the aerial vehicle may be suited for a connection to the terrestrial cellular network.

FIG. 10 shows a schematic architectural more detailed view of an antenna subsystem shown in FIG. 2.

FIG. 11 shows a more detailed view of how a flight path coordination entity informs the aerial vehicle of the preferred positions to be taken by the antenna elements at the aerial vehicle.

FIG. 12 shows an example schematic view of a connection of the aerial vehicle to the radio access network during the flight.

FIG. 13 shows a further schematic view of how the aerial vehicle is connected to the terrestrial cellular network during a flight at different flight path positions.

FIG. 14 shows a schematic more detailed view of how a flight path coordination entity can be implemented in a network.

FIG. 15 shows an example flowchart of a method carried out by the transceiver system used in an aerial vehicle.

FIG. 16 shows an example flowchart of a method carried out at the flight path coordination entity shown in FIG. 2.

FIG. 17 shows a schematic representation of a transceiver system used to control connection between the aerial vehicle and the terrestrial network.

FIG. 18 shows a schematic architectural view of a flight path coordination entity used to provide data to the aerial vehicle helping the aerial vehicle to correctly position the container elements.

### DETAILED DESCRIPTION

In the following embodiments of the invention will be described in detail with reference to the accompanying drawings. It is to be understood that the following description of embodiments is not to be taken in a limiting sense. The scope of the invention is not to be intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person with skill in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof. Within the context of the present application, the term user equipment or mobile entity refers to a device which is equipped with a subscriber identity module, SIM comprising unique identities such as the international mobile subscriber identity, IMSI, the temporary mobile subscriber identity, TMSI or the Globally Unique Temporary UE identity, GUTI. In the present context and as will be discussed below the UE is fixedly mounted to an aerial vehicle and represents an application which is running in the aerial vehicle. The UE can be used for any aerial vehicle application by which traffic is generated between the aerial vehicle and a terrestrial cellular network.

In the following a solution will be explained in more detail in which an aerial vehicle establishes a low interference, robust and high capacity consolidated communication link to a terrestrial cellular network for aerial vehicle application usage. This is obtained with a transceiver system including a control entity and an area antenna subsystem and one or several UEs connected to the aerial vehicle. The control entity and the antenna subsystem supports each UE so that it connects to a unique radio base station of a terrestrial cellular network and avoids downlink or uplink transmission interference to other UEs and radio base stations through directional antennas providing preferably non-overlapping segmented transceiver areas. Since multiple radio links are used, the control entity, also called UE controller hereinafter, provides the consolidated communication link to the applications in the aerial vehicle and a network controller secures a communication link consolidation in the terrestrial network.

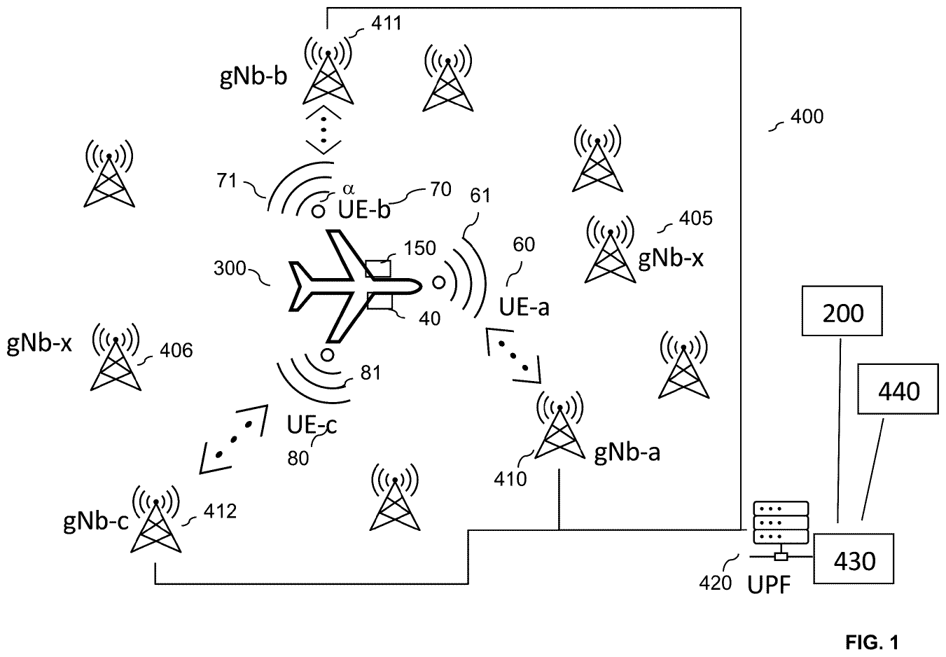

FIG. 1 shows a schematic view of the situation in which an aerial vehicle 300 is traveling on a flight path. The aerial vehicle may be an unmanned aerial vehicle or a manned aerial vehicle. Different UEs such as UEs 60, 70 and 80 are fixedly connected at predefined locations in the aerial vehicle and an antenna subsystem is provided comprising different antennas which have sectorized and substantially non-overlapping transceiver areas 61, 71, and 81. The transceiver area is a three-dimensional spherical sector indicating the main transmission and receiving direction of the antenna entity connected to each of the UEs. In the example shown an opening angle a for the main transceiver area is between 90 and 120 degrees. This angle a can depend on the number of UEs connected to the airplane. In the example shown with three UEs the opening angle can be up to 120 degrees and when four UEs are connected to the vehicle 300 the opening angle may be 90 degrees. In general the different transceiver areas 71, 61 and 81 should not overlap and the opening angle is calculated with 360/n degrees, with n being the number of connected UEs.

The aerial vehicle 300 furthermore comprises a control entity or UE control entity 150 and an application 40 which is exchanging data via a cellular network 400 with a network application 440. The cellular network 400 comprises different radio access nodes wherein each of the UEs on the vehicle 300 is connected to a different access node so that UE 60 is connected to radio access node 410 whereas UE 80 is connected to access node 412 and UE 70 is connected to access node 411. Furthermore additional access nodes such as nodes 405 or 406 are shown which are preferably not used for a connection to the airplane as will be discussed in further detail below. For the cellular network a user plane function, UPF 420 is shown, a flight path coordination entity 200 and a network controller 430 are indicated. As will be explained further below the flight path coordination entity 200 will determine, for a flight path of the aerial vehicle, which radio access nodes should be used on the flight path in dependence on the position of the aerial vehicle. This information will then be transmitted to the aerial vehicle and used by the vehicle for selecting the appropriate radio access nodes of the cellular network 400.

The network application 440 may be located on an internet side of the UPF 420.

UE 60 covers a three-dimensional transmission area or sector in the direction of the air travel having an opening angle of slightly less than 120 degrees, UE 70 and 80 covers similar sectors to the left and backward and to the right and backward relative to the direction of air travel. The three sectors or transceiver areas 61, 71 and 81 do not overlap securing that two UEs never have line-of-sight to the same radio access node and thus, if no strong reflected radio signals crossing sectors exist, will never transmit to or receive from the same radio access node.

During travel the cellular network such as a 5G network has ordered UE 60 to establish a connection to radio access node 410. The network has determined that the radio access node 410 provides a favorable radio connection to the UE as part of the measurement reports which radio access nodes are visible through the external antenna of UE 60. In the same fashion, UE 70 is connected to radio access node 411 and UE 80 is connected to radio access node 412. The two radio access nodes 405 and 406 may also have favorable radio characteristics as far as the signal strength is concerned. However due to the direction of travel, the Doppler effect is too high for any of the UEs to establish a connection to any of these radio access nodes. During the time the network may attempt to direct UE 60 or UE 80 to one of the nodes 405 or 406, UE 70 maintains a connection. This might be the case when the network and the aerial vehicle do not understand on beforehand that these radio base stations will not work in view of the high Doppler effect, so that a “normal” solution that each UE tries after a while the second best radio base station. Accordingly it is beneficial to have several UEs provided in the aerial vehicle

The application in the aerial vehicle is a placeholder to applications that run in the aerial vehicles. Examples are air traffic management, aerial vehicle control, aerial vehicle maintenance, aerial vehicle video streams and aerial vehicle passenger entertainment. It is possible to use terms like C2, command-and-control or C3, command, control and communication. The network application 440 is a placeholder for the application part that resides on the Internet and/or within enterprises. The flight path coordination entity 200 instructs the aerial vehicle 300 of favorable antenna positions based on flight path data received from the aerial vehicle in combination with radio performance and radio network configuration data received from the network. Accordingly entity 200 sends connection data to the aerial vehicle 300 including the information in what direction relative to the flight path the antennas of the different UEs should be directed or shall point.

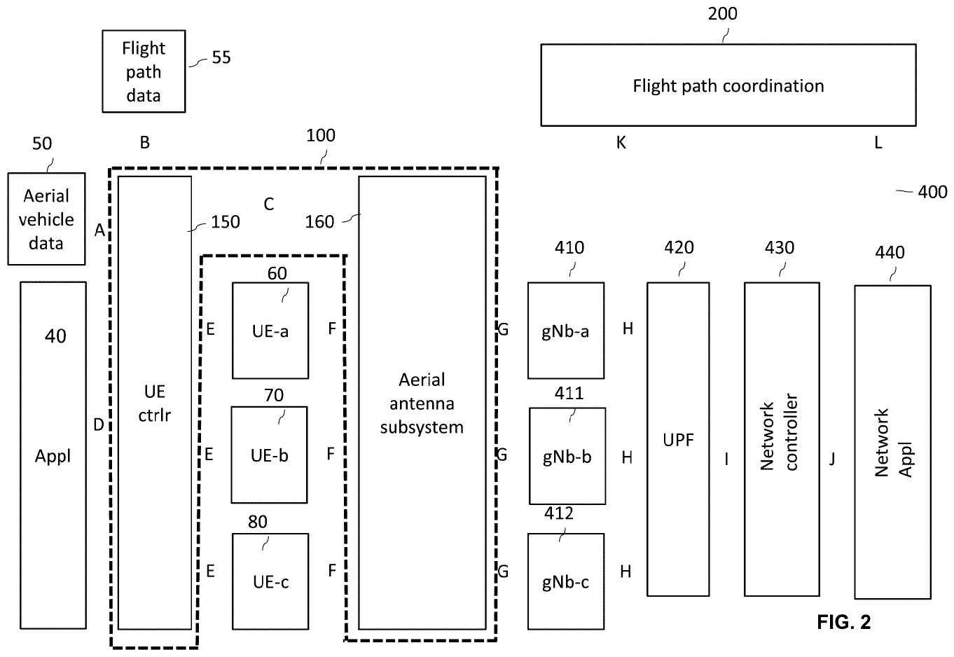

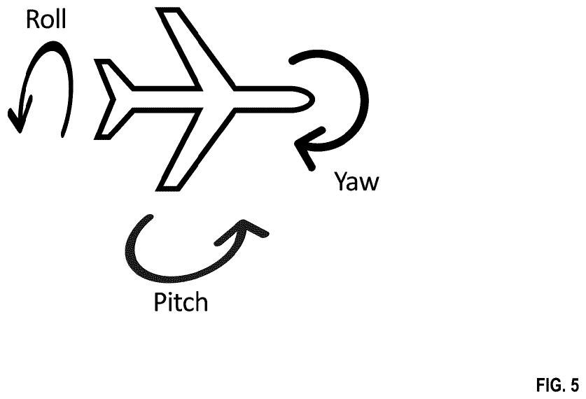

FIG. 2 shows a consolidated block diagram and the corresponding interfaces between the involved entities. A transceiver system 100 comprises the control entity for the UE 150 and antenna subsystem 160 and the transceiver system 100 is responsible for the operation at the side of the aerial vehicle 300. FIG. 2 furthermore shows schematically that the transceiver system 100 receives aerial vehicle data 50 which contains information dynamically generated by the aerial vehicle on interface A and the information is delivered to control entity 150. The data is generated by aerial vehicle sensors and systems not shown and it may include information such as the roll, pitch and yaw angle as shown in FIG. 5 or an exact position in space.

Returning to FIG. 2 the flight path data 55 contains information about the flight path of the vehicle 300 in form of direction, position, speed, and time. The flight path information is delivered to the control entity 150 on interface B. Flight management applications like air traffic management and/or unmanned aircraft system traffic management, UTM, instructs the aerial vehicle of the flight path. The application 40 and network application 440 symbolize ATM (Air Traffic Management), UTM (Unmanned Aircraft System Traffic Management) logic located in the aerial vehicle and the ATM, UTM system of an authority or enterprise. Other applications can be an aerial vehicle application like a video camera uplink, or a command and control application. There are multiple applications in each vehicle 300. Each application communicates with an instance of the network application 440. The communication may be implemented by sending or receiving data to or from control entity 150 on interface D.

The control entity 150 uses the information received on the interfaces such as interfaces A and B and instructs the antenna subsystem 160 how to direct the UE transmissions. The control entity 150 furthermore receives or transmits data on interface D and splits or consolidates it across the UEs in a multipath connection on interface E to the different UEs 60, 70 or 80.

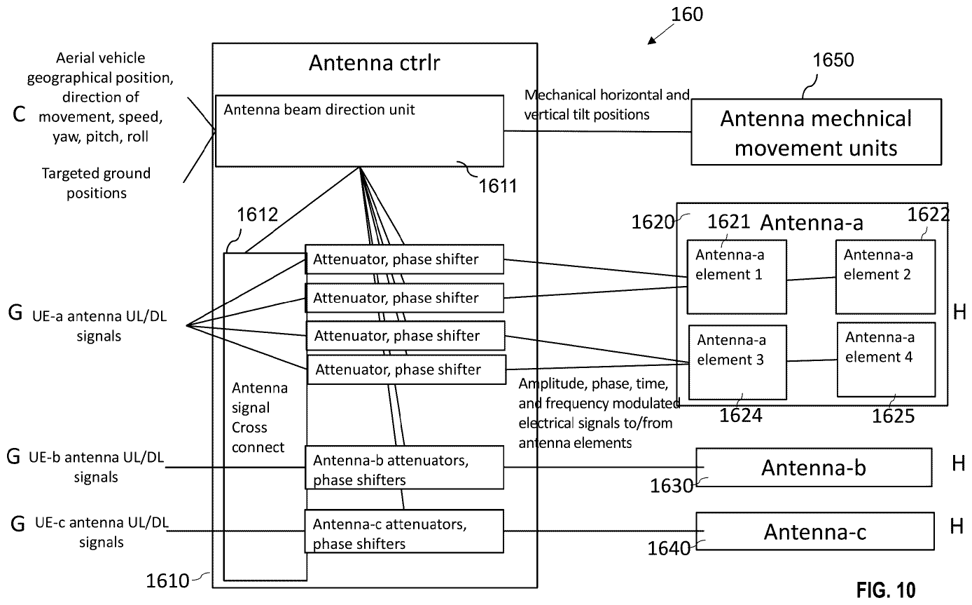

The UEs 60-80 can be implemented as LTE or New Radio, NR UEs. They receive or send application data on interfaces E and communicate with the radio access nodes on the aerial interfaces F. Physically the antenna ports may be connected on interfaces F to the aerial antenna subsystem. The antenna subsystem 160 which will be discussed in further detail in connection with FIG. 10 receives the targeted antenna directions for each UE from the control entity 150 on interface C and relates the UE antenna signals in uplink or downlink directions on interfaces F. The subsystem 160 uses the information from interface C to direct the external antenna and corresponding interface F signals from each UE.

The radio access nodes 410, 411 and 412 are radio access nodes located in the terrestrial network. Each of the access nodes is connected to the corresponding UE over the air interface.

The UPF 420 is addressed by the application block and is located in the terrestrial network providing standard terrestrial network functionality like a load sharing and may cause different UPF instances to be selected per UE.

The network controller 430 terminates the multipath connection that the UE controller has initiated thereby logically connecting interface D to interface J. This allows the application 40 to communicate with the network application 440. Network controller 430 can communicate via a multipath connection with one or more UPFs 420 over interface I.

The network application 440 is the network side application that communicates with the aerial application 40.

The flight path coordination entity 200 advises the control entity 150 over interface L via the network controller 430 of favorable antenna directions. The coordination entity 200 hereby combines flight path data received from control entity 150 over interface L with radio performance and configuration data accessed over interface K from the radio network.

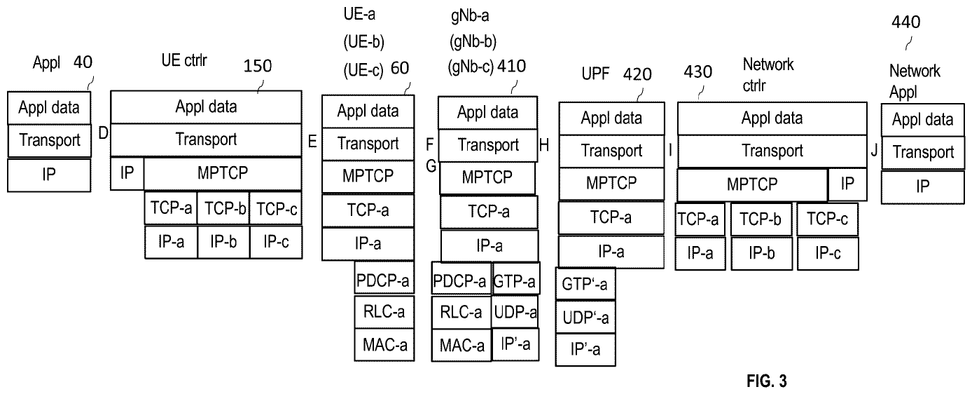

FIG. 3 shows a possible implementation of a user plane protocol stack. The control entity 150 and network controller 430 implement an IP tunnel that connect the application 40 and the network application 440. The control entity 150 sets up a tunnel to the network controller 430 via the three links offered by the different UEs. The tunnel can be set up using a multilink protocol like the multipath TCP protocol.

FIG. 3 shows the principle protocol stacks. Excluded is the connection between the application 40 and the UE control entity 150 which depending on the type of application is implemented as Wi-Fi, Bluetooth or a wired Ethernet connection. FIG. 3 also only shows the protocol stack for the data flow for UE 60 and the corresponding radio node 410. The data flows for UE 70 and UE 80 and the corresponding radio access nodes exist in parallel. Security layers between the application and the network application instances are included in the place holding transport protocol layer.

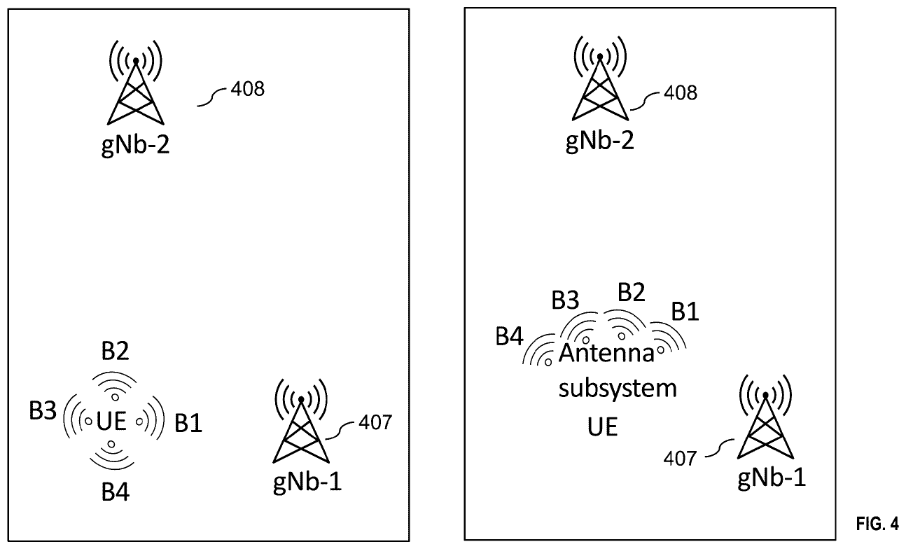

FIG. 4 discusses the possible options for the UE connection to one of the radio access nodes. In the left-hand part of FIG. 4 a UE such as UE 60, 70 or 80 is measuring which radio access node it prefers to access at initial access or mobility management measurement procedures. The UE issues beams B1 through B4 in a 360 degree fashion to access which of the radio access nodes 407 and 408 offer the most of favorable radio conditions. As node 407 is closer than node 408 to the UE it is typically perceived as having more favorable radial conditions. In the right hand part of FIG. 4 the UE antenna ports are connected to an antenna subsystem that maps the 360° UE beams B1 through B4 onto a 120 decree sector as it might be used in the present application. The UE beam and measurement logic remains unchanged. When the UE is airborne, only radio access node 408 has line of site conditions and will thus typically be perceived as having more favorable radial conditions. Closer to the ground, radio signal reflections will influence whether node 407 or 408 is perceived as being more favorable.

FIG. 5 shows the different movements of the aerial vehicle including the yaw angle, the left or right turning, the pitch angle, turn up and down and the roll angle corresponding to a left or right rotation. During these possible movements the UE may lose the line-of-sight connection to the corresponding radio access node. The transceiver system 100, here the antenna subsystem may evaluate the speed of the aerial vehicle movement and if the movement speed is above a threshold, the antenna elements are reconfigured to maintain a line-of-sight connection to the corresponding radio access node. For movement speeds below a threshold, the radio mobility management procedures are expected to compensate the movement.

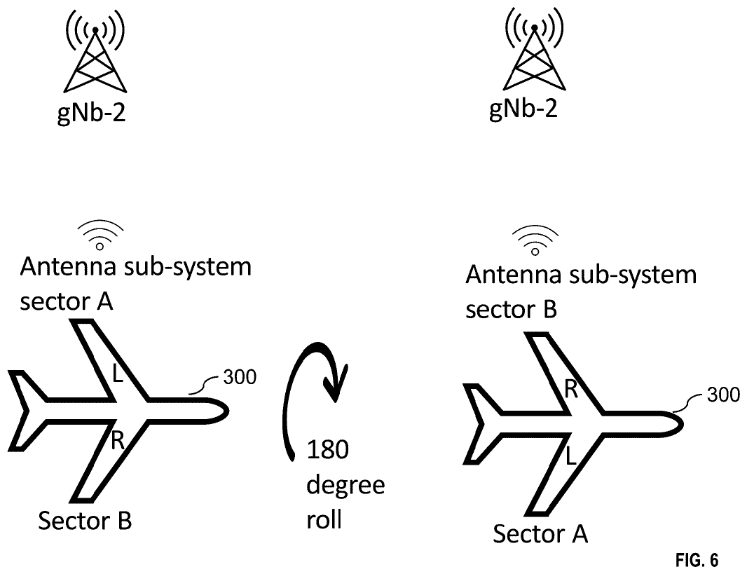

FIG. 6 discusses how the selection of an antenna may change depending on the aerial vehicle position and orientation. In the left part of FIG. 6 the aerial vehicle and the UE uses an antenna subsystem from sector A to communicate with the radio access node. The vehicle 300 may then make a rapid 180 degree roll movement and this movement which can be performed in less than 1 second, can cause sector A to point away from the radio access node. To secure the line-of-sight connection to the radio access node, the antenna subsystem upon rapid roll detection connects sector B, another antenna entity to the radio access node allowing the UE beam to point to the needed radio access node.

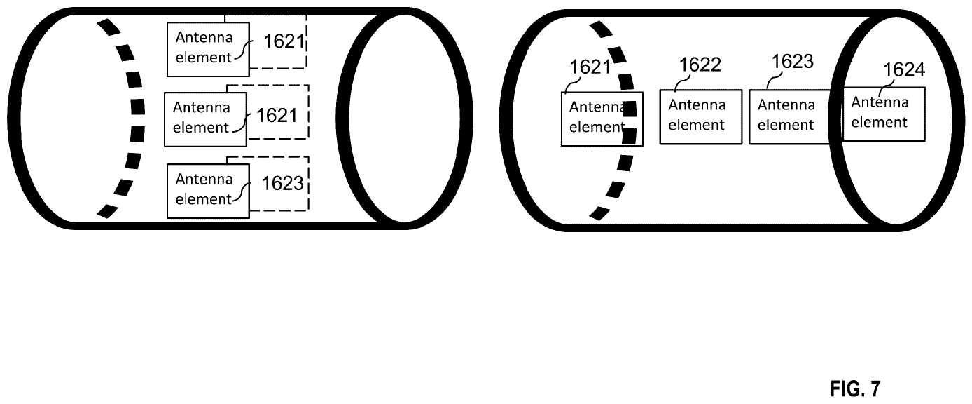

FIG. 7 shows different options for the antenna placement in the aerial vehicle. The left side of FIG. 7 shows on the left side antenna elements 1621-1623 which are fastened in a circular fashion around an aerial vehicle's fuselage. During a vehicle roll movement this allows the antenna subsystem to select antenna elements that have a line-of-sight condition to the terrestrial radio base stations regardless of the roll position.

On the righthand side of FIG. 7 the different antenna elements 1621-1624 are provided in a linear row along the fuselage. Multiple antenna rows may implement antenna element matrices. This antenna element orientation allows the antenna subsystem through amplitude and phase shifts to shape the electromagnetic radiation into beams.

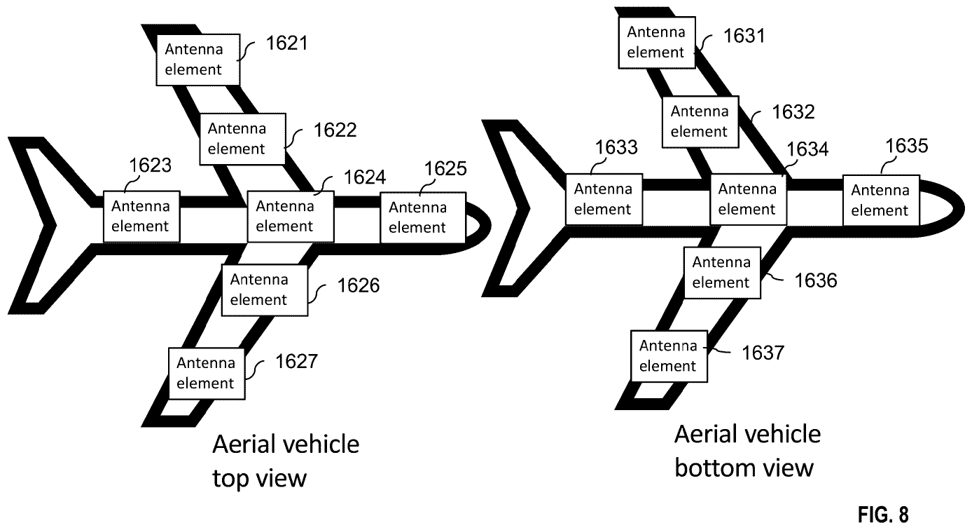

Referring to FIG. 8 antenna elements 1621-1627 can be placed on a top of the aerial vehicle on the wing and fuselage surfaces, and it is possible that antenna elements such as elements 1631-1637 may be provided on the bottom part of the wing and fuselage surfaces. This can help to achieve line-of-sight conditions and to shape the electromagnetic waves for beamforming in order to obtain the desired transceiver area with non-overlapping areas.

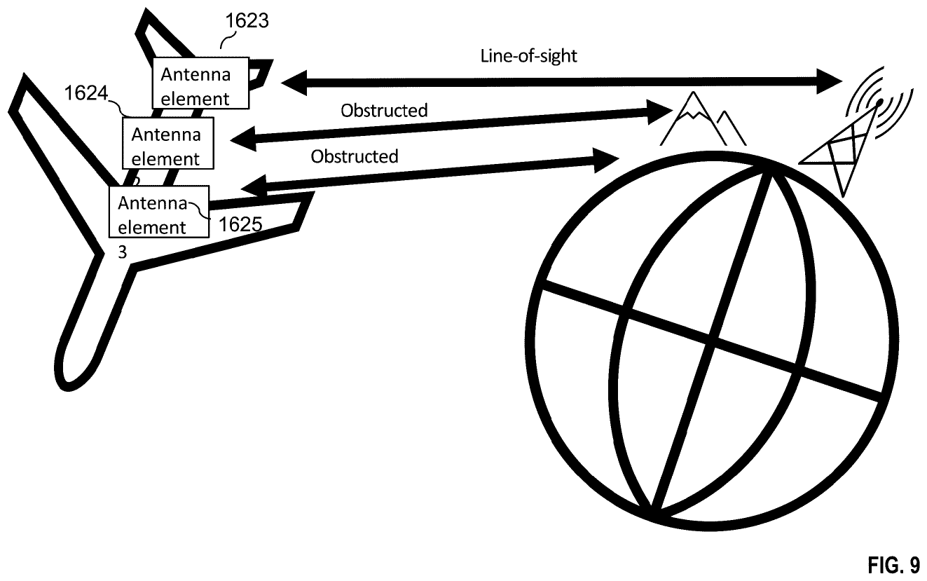

FIG. 9 shows a situation where some of the antenna elements may provide line-of-sight to a radio base station, whereas other antenna elements are less suitable for a radio connection to the terrestrial network. Thus, even when facing in the direction of a radio base station antenna elements such as elements 1624 and 1625 might not have a line-of-sight to the radio base station. In the situation shown only antenna element 1623 has line-of-sight to the radio base station while the terrain respective the curvature of earth obstructs the line-of-sight for the other two antenna elements. Examples of other reasons are when buildings or parts of an aerial vehicle itself obstruct the line of sight.

In the following the aerial vehicle interference is discussed in more detail.

An airborne UE such as the UEs 60-90 connected to a cellular terrestrial network drives uplink and downlink interference for the terrestrial network. The higher the airborne UE is located the more interference will be generated in this cellular network. To compensate for the interference the terrestrial network will allocate an increased amount of radio resources for the traffic. If the radio resources get depleted, the capacity of the terrestrial network available for terrestrial and airborne UEs will be negatively affected.

The increased downlink interference originates from the fact that an airborne UE will be exposed to downlink transmissions from more radio stations compared to a UE located on the ground. The airborne UE signals that it is a subject to interference and the terrestrial network can allocate additional radio resources in the downlink.

The increased uplink interference originates from the fact that the airborne UEs uplink transmissions reaches more radio base stations compared to corresponding uplink transmission from terrestrial UEs. The radio base stations conclude they are subject to uplink interference and allocate increased radio resources for the UEs to use in the uplink.

The higher up the airborne UE is located, the more radio base stations will have line-of-sight to the UE and experience increased interference, the more UEs are airborne, the more interference will be generated. The present application overcomes some of the above identified problems using a transceiver system and specially an area antenna subsystem as discussed in connection with FIGS. 1, 2 and 10. The aerial antenna subsystem 160 comprises an antenna control entity 1610, a unit for the antenna mechanical movement 1650, and the different antenna entities 1620, 1630 and 1640. For one of the antenna entities 1620 the different antenna elements 1621-1624 are symbolically shown.

In the subsystem 160 of FIG. 10 the vehicle is equipped with three UEs such as UEs 60-80 shown in FIG. 1. In the same way three antenna entities 1620-1640 are provided and each antenna entity can be provided with four antenna cross-polarized elements. To simplify the description in the example shown the antenna elements are grouped into antenna entities 1620, 1630, and 1640, but it is possible to use antenna elements from several antenna entities for the same UE.

The antenna control entity 1610 comprises a beam direction unit 1611 which receives information about the position of the aerial vehicle, the direction of movement, the speed and the yaw, pitch and roll angle. Furthermore the targeted ground positions are received where the corresponding base stations are located as generated by the flight path coordination entity 200. In addition to the beam direction unit 1611 a unit 1612 is provided connecting the different antenna signals using attenuators and phase shifters.

The antenna control entity 1610 receives the antenna uplink and downlink signals for the different UEs and then determines the amplitude, phase, time and frequency modulated electrical signals sent to the antenna elements or received from the antenna elements.

The number of UEs, the number of antennas and the number of antenna elements per antenna can vary depending on the type of aerial vehicle, the type of application, the UE type used or any other regulations and parameters. Increasing the amount of UEs, antennas and antenna elements may increase the performance of the communication link to satisfy requirements such as regulatory, flight path and application requirements. Lowering the amount of UEs, antennas or antenna elements can be advantageous to reduce the weight, footprint, power consumption and cost of the antenna subsystem.

A separation of the UE from the antenna subsystem can be beneficial as it allows available and cost efficient UEs to be reused in the environment of an aerial vehicle. Furthermore it limits the aerial vehicle adaptations to the antenna subsystem and gives freedom to aerial vehicle adaptations beyond what could be feasible in mass market UEs.

As shown in FIG. 10 antenna subsystem 160 comprises the antenna control entity 1610 which forwards the antenna signals from and to the UEs, calculates how the UE antenna signals should be mapped to the aerial vehicles antenna elements and calculates, how each antenna element shall be mechanically positioned. The antenna control entity is subdivided into the beam direction unit 1611, a unit 1612 for cross connection and antenna signal attenuators, amplifiers, filters and phase shifters. The unit responsible for the mechanical antenna movement 1650 is able to tilt the antenna elements physically and vertically and horizontally and last but not least the antenna entities 1620, 1630 and 1640 with the antenna elements transmit and receive over the air interface H.

The antenna control entity 1610 receives information on interface C about the aerial vehicle geographical position such as longitude, latitude and height, a direction of movement and speed and the attitude in terms of yaw, pitch or roll. Furthermore the ground positions are received that the antenna elements shall target to create the line-of-sight conditions in order to minimize the interference in the cellular network.

Based on the information received the beam direction unit 1611 calculates in what direction the three UEs shall transmit or receive to reach the targeted ground positions while minimizing interference and the securing of a stable connection.

The beam direction unit 1611 uses the antenna signal cross connect to assign one of the antennas to the UE so that the UE antenna can point to the targeted ground position. The antenna assignment may vary during the flight. If the aerial vehicle makes a rapid turn, like a roll, antenna beam direction unit, if needed to maintain the targeted ground position direction, can assign another antenna to the UE. The antenna reassignment is done since the radio network link adaptation and handover logic is not robust enough to accommodate sudden changes or loss the signal without impacting the connection. The beam direction unit 1611 furthermore calculates for each antenna the antenna tilt to face the targeted ground position and instructs the antenna mechanical movement unit of wanted vertical and horizontal tilt. The unit 1611 furthermore calculates and applies the attenuation, amplification, filtering and phase shift for each antenna element to further direct the antenna transmission or reception.

In connection with FIG. 11 the interaction of the flight path coordination entity 200 with other entities is discussed in more detail. Entity 200, located in the radio network part, signals to the control entity 150 over interface L in what geographical direction the aerial antennas shall point to achieve a stable connection. Control entity 150 receives the flight path data over interface B and forwards speed, direction, height, position and current antenna positions to the flight path coordination entity 200.

Entity 200 accesses radio network configuration data from the radio network over interface K and determines which set of radio access nodes are within the flight path and which offer a favorable connection from a geographical location point of view. Entity 200 also accesses radio performance data over interface K to determine the aerial vehicles current connection performance and the radio performance of the radio access node in the set.

For each UE in the vehicle 300 with a connection the radio network, the entity 200 selects a radio access node out of a set of radio access nodes that drive good radio performance for the aerial vehicle connection and contribute to the overall performance of the radio network. Radio parameters that are evaluated include downlink and uplink interference, the load at the radio access node and the radio frequencies offered by radio access node.

The coordination entity 200 subsequently instructs the UE control entity 150 point the aerial vehicle's antennas in the direction of the selected radio access nodes.

In the case that the coordination entity finds that suitable radio conditions cannot be achieved for one antenna, and the other antennas offer suitable connections the coordination entity can instruct the control entity 150 to only receive but not transmit on this one antenna until the antenna can be positioned for good radio condition again. This procedure may be repeated every few seconds to secure that the direction selection of the radio access node adjust with the geographical position of the vehicle and the shifting radio network conditions.

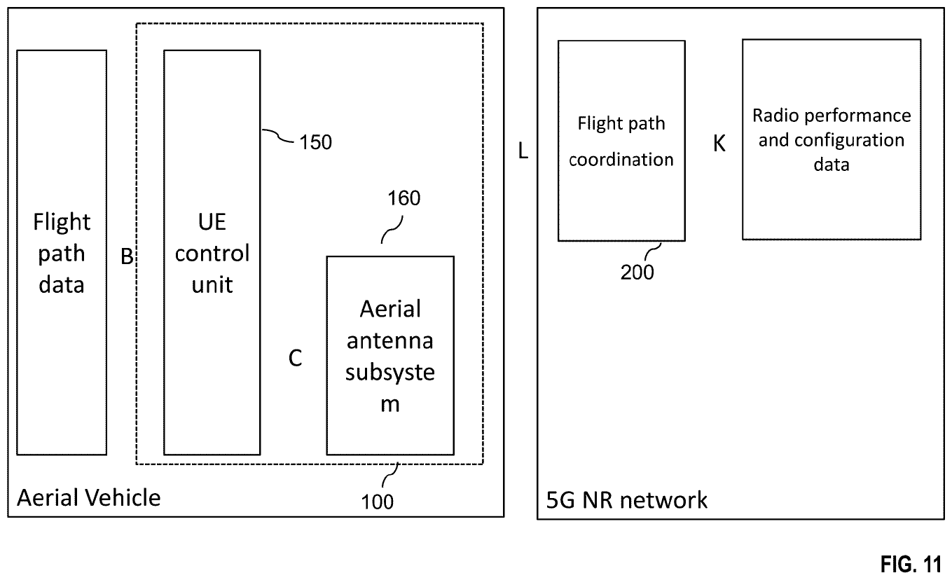

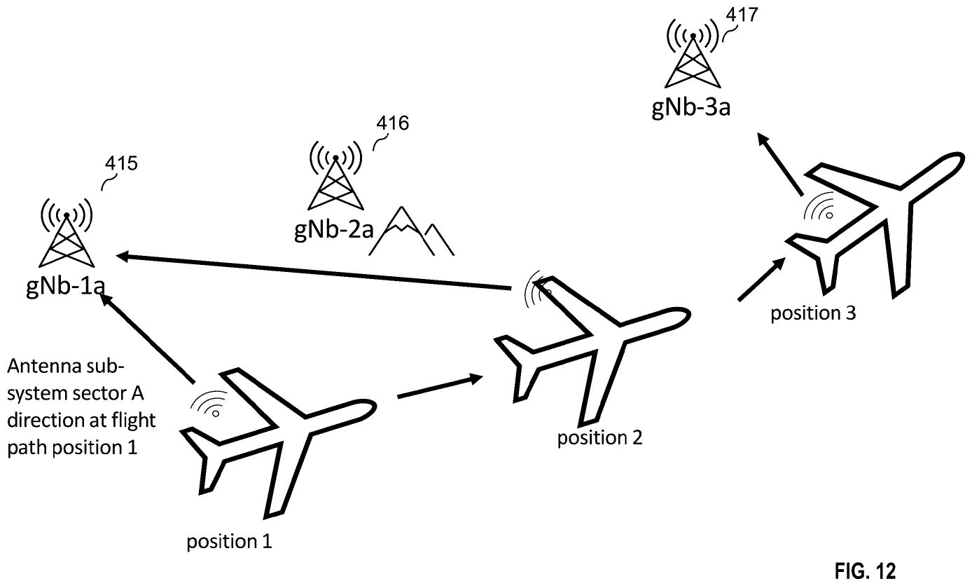

In FIG. 12 an aerial vehicle moves from flight path position 1 to position 2 and then to position 3. In position 1 the antenna subsystem has directed its antenna for one sector A used by one UE in the direction of radio access node 415. The coordination entity 200 receives the information from the UE control entity 150 that the aerial vehicle is moving in the direction of position 2. The coordination entity determines that radio access node 416 due to its proximity would temporarily offer better radio conditions for antenna sector A. However due to the upcoming terrain or mountain the radio signal would be blocked before reaching position 2. The coordination entity therefore directs the UE controller to continue to direct the sector A antenna in the direction of radio access node 415. Later when approaching position 3, the coordination entity directs the UE control entity to direct the antenna in direction of radio access node 417 which has been evaluated to offer better radio conditions than radio access node 415.

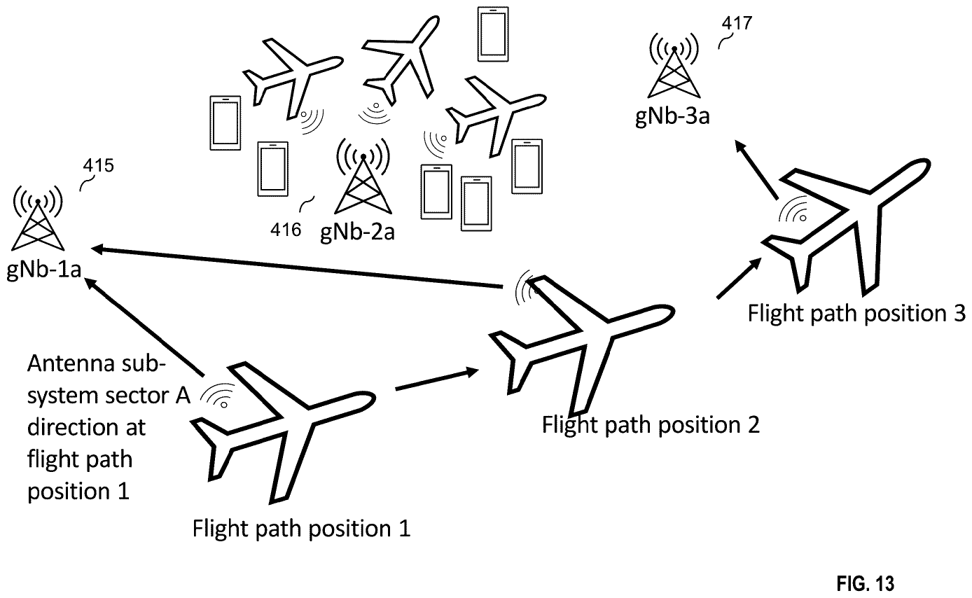

FIG. 13 describes a similar situation, however, instead of the terrain obstruction, it is high load and uplink or downlink interference that make the coordination entity instruct the UE control entity 150 to direct the antenna first towards radio access node 415 but not towards node 416.

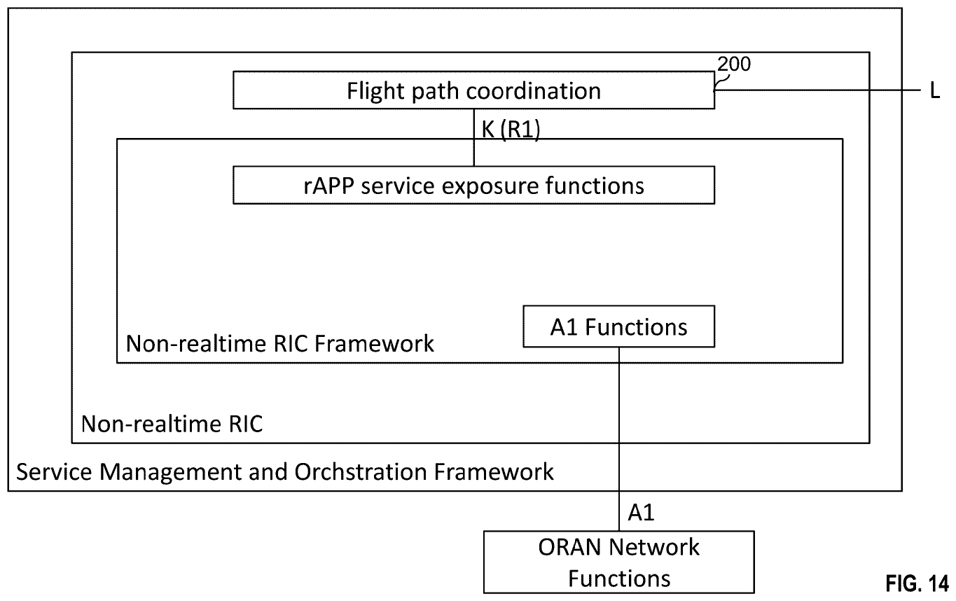

FIG. 14 shows a possible implementation of the coordination entity 200. The entity 200 can be implemented in form of an Open RAN, radio access network, entity. Open RAN specifies how entity 200 can access the 5G new radio network data on the R1 interface. In the present application the letter K has been used to name this interface. The open RAN implementation specifies that the service exposure functions of entity 200 interact with other applications located in the non-realtime RIC (RAN intelligent controller) and that communication to the 5G new radio network takes place over the A1 interface which connects to the ORAN network functions. The non-realtime RIC is located within the service management and orchestration framework.

The coordination entity further uses interface L to connect to the aerial vehicle's UE controller via the user plane.

Given sufficient interfaces and performance the control entity 150 may also be implemented as a software package on top of an already existing microprocessor or mobile phone platform. The control entity 150 may also be implemented as a software package on top of one of the UEs used to establish the links. As far as the network controller 430 is concerned a software implementation such as a virtual network function or a cloud native implementation with one or more containers is possible. The network controller may be co-located with or integrated in other functions like the UPF.

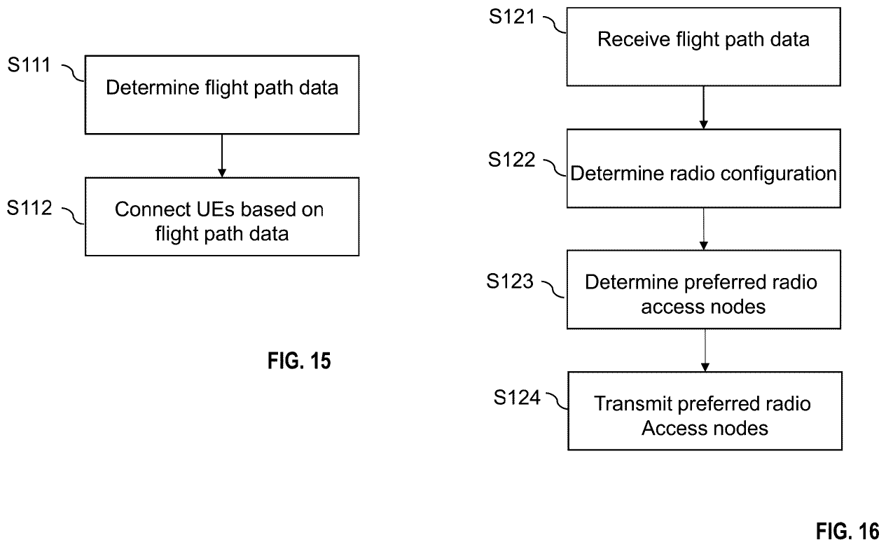

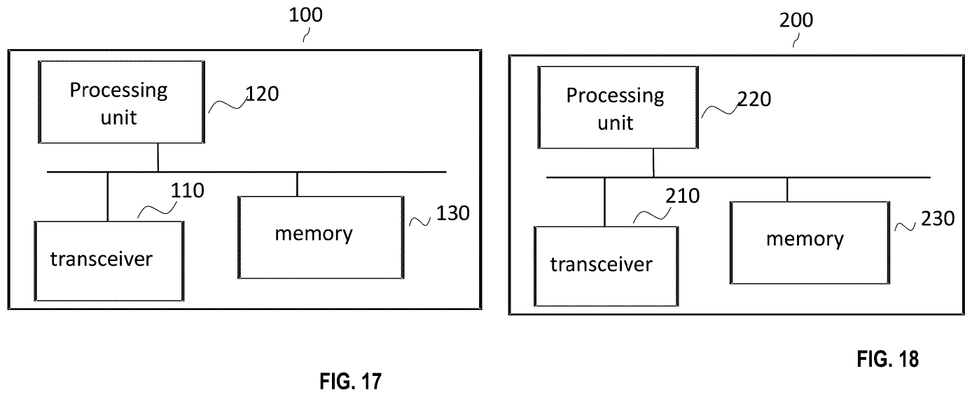

FIG. 15 shows some of the steps carried out by the transceiver system 100 in the discussion above. In step S111 the transceiver system 100 determines the flight path data of the aerial vehicle and in step S112 it connects the UEs to at least one of the two antenna entities in dependence on the flight path data.

FIG. 16 summarizes some of the steps carried out by the flight path coordination entity 200 which in step S121 receives the flight path data of the aerial vehicle through the network wherein the flight path data indicate the flight path of the aerial vehicle. In step S122 the coordination entity furthermore determines the radio network configuration data with the locations of the radio access nodes used in the radio access network of the cellular network. In step 123 the coordination entity determines connection data which indicate in which direction the antenna entity is connected to the aerial vehicle should emit signals relative to the flight path based on the flight path data and the radio network configuration data. In this step the entity 200 determines which of the radio access nodes provide the best connection for the different position of the aerial vehicle during the flight based on the flight path and the locations of the radio access nodes and in step S124 the connection data are transmitted in direction of or to the aerial vehicle so that the aerial vehicle can receive the transmitted connection data in order to determine how to adjust the direction of the antenna entities in the vehicle.

FIG. 19 shows a schematic architectural view of the transceiver system 100 which can operate as discussed above. The transceiver system 100 comprises an interface 110 symbolizing the option to transmit user data or control messages to other entities and to receive user data or control messages from other entities wherein the interface 110 can implement the different interfaces shown in FIG. 2. The transceiver system furthermore comprises a processing unit 120 which is responsible for the operation of the transceiver system 100. The processing unit 120 can comprise one or more processors and can carry out instructions stored on a memory 130 wherein the memory may include a read-only memory, a random access memory, a mass storage, a hard disk or the like. The memory can furthermore include suitable program code to be executed by the processing unit 120 so as to implement the above-described functionalities in which the transceiver system is involved.

FIG. 20 shows a schematic architectural view of the flight path coordination entity 200 which comprises an interface 210 symbolizing the interfaces shown in FIG. 2 or 14. The coordination entity 200 furthermore comprises a processing unit 220 which is responsible for the operation of the coordination entity. The processing unit 220 can comprise one or more processors and can carry out instructions stored on a memory 230 wherein the memory may include a read-only memory, a random access memory, a mass storage, a hard disk or the like. The memory 230 can furthermore include suitable program code to be executed by the processing unit 220 so as to implement the above-described functionalities in which the flight path coordination entity 200 is involved.

From the above said some general conclusions can be drawn for the involved entities.

As far as the transceiver system is concerned, the control entity 150 can be configured to determine furthermore in addition to the flight path data the aerial vehicle data including at least information about the orientation of the vehicle in space. The control entity is then configured to connect the at least one UE to one of the different antenna entities based on the determined aerial vehicle data. This was discussed in connection with FIGS. 5 and 6 where the aerial vehicle data is considered for selecting the antenna entity.

The at least two antenna entities 1620 or 1630 may be configured such that each of the at least two antenna entities has a sectorized main transceiver area for transmitting information to the connected radio access node or for receiving information from the connected radio access node wherein the different transceiver areas are not overlapping so that the main transceiver area from one antenna entity is not overlapping with the sectorized main transceiver area from any of the other antenna entities.

The sectorized main transceiver area can cover a coverage area defined by an opening angle such as angle alpha originating at the corresponding antenna entity which is smaller than the angle defined by 360 degrees divided by a total number of the at least two antenna entities. For in total three antenna entities the opening angle may be smaller than 120 degrees, for four antenna entities the angle may be smaller than 90 degrees.

The control entity 150 can be connected to at least two user equipments and the two user equipments can be connected to antenna entities such that a first one of the at least two user equipments is connected to a first one of the antenna entities and a second one of the two user equipments is connected to a different second one of the antenna entities. This means that each UE in the aerial vehicle is connected to a different antenna entity.

The control entity may be configured to change the connection of at least one UE from one of the at least two antenna entities to another of the at least two antenna entities in response to the fact that the aerial vehicle data indicate a changed orientation of the aerial vehicle in space. This situation was discussed in connection with FIGS. 5 and 6.

The control entity 150 can be furthermore configured to select a connection to one of the at least two antenna entities such that the opening angle between a direction of travel of the aerial vehicle and a direct connection to the radio access node to which the antenna entity is connected is larger than a threshold angle, by way of example larger than 15 degrees or less than 165 degrees, especially when the speed of the aerial vehicle is larger than a threshold value. However smaller angles or angles close to 180 degrees may also be used depending on the network layout, or the speed of the aerial vehicle. Furthermore, as the aerial vehicle moves along the same direction, this angle will change and decrease when the corresponding radio access node is located opposite the direction of travel or may increase when the radio access node is located in front of the direction of travel. The transceiver system could be designed as such that preferably the connected radio access node is changed, if possible when the above-identified angles are reached in order to minimize a possible Doppler effect.

The transceiver system, here the control entity 150 may be furthermore configured to receive the location information provided from the terrestrial cellular network allowing the control entity to determine to which preferred terrestrial area each of the at least two antenna entities should be directed in dependence on a position of the aerial vehicle. The control entity then instructs each of the at least two antenna entities to direct the corresponding sectorized main transceiver areas based on the received location information. This location information may have been determined by the flight path coordination entity as discussed above. Furthermore, the control entity may be configured to initiate a transmission of the flight path data to the terrestrial network, wherein the received location data include the preferred terrestrial area in dependence on the flight path.

Furthermore, the transceiver system, i.e. the control entity 150 or antenna subsystem 160 can be configured to combine the location information to the flight path in order to determine to which preferred terrestrial area to direct the at least two antenna entities should be directed in dependence on a position of the aerial vehicle in the flight path.

The control entity can furthermore receive the message originating from the terrestrial cellular network which informs the transceiver system of an interference occurring at the terrestrial cellular network in a defined geographical area originating from the aerial vehicle. The transceiver system can react based on this message with either determining which of the at least two antenna entities is transmitting in direction of the defined area and decrease a signal transmission strength for the determined antenna entity. Furthermore, it may change a connection of the connected user equipment to another of the antenna entities.

Each antenna entity may be configured to exchange application data from one of several applications running in the aerial vehicle between the user equipment and the network applications connected to the terrestrial network wherein the applications differ from one another.

The control entity can be further configured to establish an IP tunnel between each of the different applications and each of the network applications. This was discussed in connection with FIG. 3.

The transceiver system can comprise an antenna subsystem 160 which comprises the at least two antenna entities and each antenna entity such as entity 1620 or 1630 comprises at least one antenna element such as elements 1621 or 1622 configured to transmit and receive antenna signal. The antenna subsystem furthermore comprises the antenna control entity 1610 which exchanges data with the connected user equipments, determines how each of the antenna elements is to be positioned in order to transmit and receive the antenna signals and which controls the tilt of the antenna elements vertically and horizontally.

As far as the flight path coordinates entity 200 is concerned when two UEs are provided in the aerial vehicle and are connected to the cellular network the flight path coordination entity can determine, for each of the user equipment the connection data and can transmit the connection data for each of the UEs in direction of the aerial vehicle. The flight path coordination entity can furthermore instruct the aerial vehicle to only receive data from one of the user equipments and not to transmit data from said one user equipment in direction of the terrestrial network. This may be helpful in case a high interference is determined.

Summarizing the present application uses multiple and sectorized UEs with a separate antenna subsystem 160 to physically separate the radio transmission directions to mitigate uplink and downlink interference. When applied perpendicular to the movement of the vehicle 300 the sectorized transmissions mitigate Doppler effects. Furthermore, the control entity 150 can instruct the antenna subsystem 160 to compensate for aerial vehicle movements which secures the sectorized UE link stability.

The UE controller can instruct the antenna subsystem 160 to direct each UE transmission in a certain direction according to the flight path so that the mobility management and the interference is optimized which increases the link stability.

Furthermore, it is possible that the control entity instructs the antenna subsystem to direct each UE transmission in a certain direction according to the flight path which optimizes the mobility management and interference which increases the link stability. Furthermore the cellular network can instruct a UE of the aerial vehicle to temporarily transmit less when the network detects this UE experience with high interference and can instruct to direct the application traffic to other UEs that have less interference.

Furthermore, the cellular network can dynamically advise on preferred antenna directions based on the flight data received from the aerial vehicle.

With three UEs provided in the vehicle and each UE covering its own non-overlapping sector the following advantages can be obtained. The interference is significantly reduced since less radio base stations are in line-of-sight per UE and it is possible to reduce the transmission or reception from a UE if it experiences high interference. Furthermore the Doppler effect can be reduced when an advantageous angle is selected relative to the base station depending on the flight direction. The risk of a communication link failure is reduced due to lobe coverage as well as due to mobility and traffic management procedures. The communication link may only fail in case the radio communication fails for all UEs simultaneously. Furthermore the risk for a communication link failure is reduced through antenna direction, compensation upon fast aerial vehicle movement. Further it allows for a consolidated and improved application communication characteristics in the case more than one UE has a connection to radio basis stations.

With the help of the transceiver system and the coordination entity it is possible for a mobile operator to own the application network endpoint. Further it enables the mobile operator to instruct the control entity 150 to manipulate the UEs to improve the terrestrial network performance and connection without impacting any 3GPP implementation in the radio access network and the UEs.

1. A transceiver system for an aerial vehicle comprising:
a control entity connected to at least one user equipment and configured to determine flight path data including information about a flight path of the aerial vehicle, and
at least 2 antenna entities fixedly connected to the aerial vehicle, wherein each antenna entity is connected to a different radio access node of a terrestrial cellular network,
wherein the control entity is configured to connect the at least one user equipment to one of the at least 2 antenna entities for a connection to the terrestrial cellular network in dependence of the flight path data.

2. The transceiver system of claim 1, wherein the control entity is configured to determine aerial vehicle data including at least information about an orientation of the aerial vehicle in space, wherein the control entity is configured to connect the at least one user equipment to one of the 2 different antenna entities based on the determined aerial vehicle data.

3. The transceiver system of claim 1, wherein the at least 2 antenna entities are configured such that each of the at least 2 antenna entities has a sectorized main transceiver area for transmitting information to the connected radio access node or receiving information from the connected radio access node which is not overlapping the corresponding sectorized main transceiver area from any other antenna entity of the at least 2 antenna entities.

4. The transceiver system of claim 3, wherein the sectorized main transceiver area covers a coverage area defined by an opening angle originating at the corresponding antenna entity which is smaller than an angle defined by 360 degrees divided a total number of the at least 2 antenna entities.

5. The transceiver system of claim 1, wherein the control entity is connected to at least 2 user equipments, wherein the control entity is configured to connect the at least 2 user equipments to the at least 2 antenna entities such that a first one of the at least 2 user equipments is connected to a first one of the at least 2 antenna entities and a second one of the at least 2 user equipments is connected to a different second one of the at least 2 antenna entities.

6. The transceiver system of claim 2, wherein the control entity is configured to change the connection of the at least one user equipment from one of the at least 2 antenna entities to another of the at least 2 antenna entities in response to the determined aerial vehicle data indicating a changed orientation of the aerial vehicle in space.

7. The transceiver system of claim 1, wherein the control entity is configured to select a connection to one of the at least 2 antenna entities such that an opening angle between a direction of travel of the aerial vehicle and a direct connection to the radio access node to which the antenna entity is connected is larger than a threshold angle, larger than 20 degrees and smaller than 165 degrees, when a speed of the aerial vehicle is larger than a threshold value.

8. The transceiver system of claim 3, wherein the control entity is configured to receive location information provided from the terrestrial cellular network allowing the control entity to determine to which preferred terrestrial area each of the at least 2 antenna entities should be directed in dependence on a position of the aerial vehicle, wherein the control entity is configured to instruct each of the at least 2 antenna entities to direct the corresponding sectorized main transceiver area based on the received location information.

9. The transceiver system of claim 8, wherein the control entity is configured to initiate a transmission of the flight path data to the terrestrial network, the received location information including the preferred terrestrial area in dependence on the flight path.

10. The transceiver system of claim 8, wherein the control entity is configured to combine the location information to the flight path in order to determine to which preferred terrestrial area to direct the at least 2 antenna entities in dependance on a position of the aerial vehicle in the flight path.

11. The transceiver system of claim 1, wherein the control entity is configured to receive a message originating from the terrestrial cellular network informing the transceiver system of an interference occurring at the terrestrial cellular network in a defined geographical area originating from the aerial vehicle, wherein based on the received message the control entity is configured to at least one of the following:
determine which of the at least 2 antenna entities is transmitting in direction of the defined geographical area and decrease a signal transmission strength for the determined antenna entity, or
change a connection of the at least one user equipment connected to one of the at least 2 antenna entities to another of the at least 2 antenna entities.

12. The transceiver system of claim 1, wherein each antenna entity is configured to exchange application data from one of several different applications running in the aerial vehicle between the at least one user equipment and network applications connected to the terrestrial network, wherein the different applications differ from one another.

13. The transceiver system of claim 12, wherein the control entity is configured to establish an IP tunnel between each of the different applications and each of the network applications.

14. The transceiver system of claim 1, wherein the transceiver system comprises an antenna subsystem comprising the at least 2 antenna entities each antenna entity comprising at least one antenna element configured to transmit and receive antenna signals, the antenna subsystem further comprising:
an antenna controller configured to exchange data with the connected user equipment, to determine how each antenna element is to be positioned in order to transmit and receive the antenna signals, and to tilt the at least one antenna element vertically and horizontally.

15-18. (canceled)

19. A method for operating a transceiver system provided at an aerial vehicle, the transceiver system comprising at least 2 antenna entities fixedly connected to the aerial vehicle, and a control entity connected to at least one user equipment, the method comprising:
determining flight path data including information about a flight path of the aerial vehicle, and when each antenna entity is connected to a different radio access node of a terrestrial cellular network, and
connecting the at least one user equipment to one of the at least 2 antenna entities for a connection to the terrestrial cellular network in dependence of the flight path data.

20-32. (canceled)

33. A method, carried out at a flight path coordination entity provided in a terrestrial cellular network, comprising the steps of:
receiving flight path data of an aerial vehicle originating from an aerial vehicle connected to the cellular network indicating a flight path of the aerial vehicle,
determining radio network configuration data including locations of radio access nodes used in a radio access network of the terrestrial cellular network,
determining connection data which indicate in which direction antenna entities connected to the aerial vehicle should emit signal relative to the flight path based on the flight path data and the radio network configuration data, and
transmitting the connection data in direction of the aerial vehicle.

34. The method of claim 33, wherein at least 2 user equipments provided in the aerial vehicle are connected to the terrestrial cellular network, wherein the flight path coordination entity further determines for each user equipment the connection data and transmits the connection data for each user equipment in direction of the aerial vehicle.

35. The method of claim 33, further instructing the aerial vehicle to only receive data from one of the user equipments and not to transmit data from said one user equipment in direction of the terrestrial network, when it is determined that an interference based on signals originating from the aerial vehicle is higher than a threshold.

36. (canceled)

37. A non-transitory computer-readable medium storing thereon a computer program comprising program code to be executed by at least one processing unit of a transceiver system, wherein execution of the program code causes the at least one processing unit to carry out the method of claim 19.

38. A non-transitory computer-readable medium storing thereon a computer program comprising program code to be executed by at least one processing unit of a flight path coordination entity, wherein execution of the program code causes the at least one processing unit to carry out the method of claim 33.
